(19) United States
(12) Patent Application Publication
(10) Pub. No.: US 2005/0281721 A1
(43) Pub. Date: Dec. 22, 2005

(54) Standby current generator for an ozonizer

(76) Inventor: Maxwell Hsu, Chung-Li (TW)

Correspondence Address: Yi-Wen Tseng, 4331 Stevens Battle Lane, Fairfax, VA, 22033, US

(21) Appl. No.: 10/871,565

(22) Filed: Jun. 21, 2004

(51) Int. Cl. B01J 19/08

(52) U.S. Cl. 422/186.07; 422/186.15

(57) ABSTRACT

A standby current generator for an ozonizer is provided. The standby current generator is connected between an ozonizer power source and the ozonizer of a multifunctional oxygenated water machine, which includes a first connecting terminal, a switch unit connected with the first connecting terminal, a first protection unit connected with the switch unit, a second protection unit connected with the switch unit and the first protection unit, a rectifying unit connected with the switch unit and the second protection unit, and a second connecting terminal connected with the rectifying unit and the switch unit. When the multifunctional oxygenated water machine is turned off, the standby current generator provides a low standby current to hold the ozonizer at a standby status. Therefore, the ozoinzer can have an optimal performance at all time and a longer lifespan.

### BACKGROUND OF THE INVENTION

The present invention is related to a standby current generator for an ozonizer, and more particularly, to a standby current generator capable of providing a low standby current to the ozonizer of a multifunctional oxygenated water machine when the multifunctional oxygenated water machine is turned off in order to hold the ozonizer at a standby status so that the ozonizer can have an optimal performance at all time and a longer lifespan.

Ozonated water has been gradually learned and accepted by consumers in modern society. As a matter of fact, ozone is very advantageous in people's daily live, especially when it is used for sterilization. The sterilizing effectiveness of ozone is prominently better than that of chlorine used in conventional method. Ozone is composed of three oxygen atoms and is rather unstable. Due to this instability, ozone easily reacts with other elements and therefore results in oxidation reaction. Because of the superior sterilizing effect, ozone has multiple functions including decomposing pesticides, disinfection, sterilization, deodorization, dechlorination, and water purification.

However, since ozone has irritant smell, it may jeopardize human body's health if the added concentration is excessive. The potable electrolised ozonated water has not only the colorless and smell-less characteristics, but also the disinfection and sterilization effects. In addition, it has a high oxidation ability which could increase the immunity and lower the blood sugar level by helping decomposing the blood sugar of people. Certainly, the contained quantity of ozone should be within a safety range for usage.

It is known that the conventional ozonizer for the ozonated water generating machine is often damaged by the transient high current when the ozonated water generating machine is turned off. Besides, since the ozonizer does not standby, the ozonated water can not be generated immediately when next user turns on the ozonated water generating machine again. It has to wait for a period of time until the ozonated water generating machine begins to provide the desired ozonated water or the potable electrolised ozonated water. Hence, it causes great inconvenience for use.

### SUMMARY OF THE INVENTION

The present invention is to provide a standby current generator for an ozonizer that resolves the above-mentioned drawbacks. According to one aspect of the present invention, a standby current generator is connected between an ozonizer power source and the ozonizer of a multifunctional oxygenated water machine. When the multifunctional oxygenated water machine is turned off, the standby current generator provides a low standby current to hold the ozonizer at a standby status. Therefore, it can provide the ozonizer with an optimal performance at all time and a longer lifespan.

Accordingly, the standby current generator of the present invention includes a first connecting terminal, a switch unit connected with the first connecting terminal, a first protection unit connected with the switch unit, a second protection unit connected with the switch unit and the first protection unit, a rectifying unit connected with the switch unit and the second protection unit, and a second connecting terminal connected with the rectifying unit and the switch unit. When the multifunctional oxygenated water machine is turned off, an applied high current provided by the ozonizer power source to the ozonizer is reduced to a low standby current so as to hold the ozonizer at a standby status.

The foregoing and other features and advantages of the present invention will be more clearly understood through the following descriptions with reference to the drawings, wherein:

### BRIEF DESCRIPTION OF THE DRAWINGS

FIG. 1 is a diagram showing the circuit of the standby current generator according to one preferred embodiment of the present invention;

FIGS. 2-3 are diagrams showing the current directions in the circuit of the standby current generator according to one preferred embodiment of the present invention; and

FIG. 4 is a flow chart showing the operating status of the standby current generator according to one preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

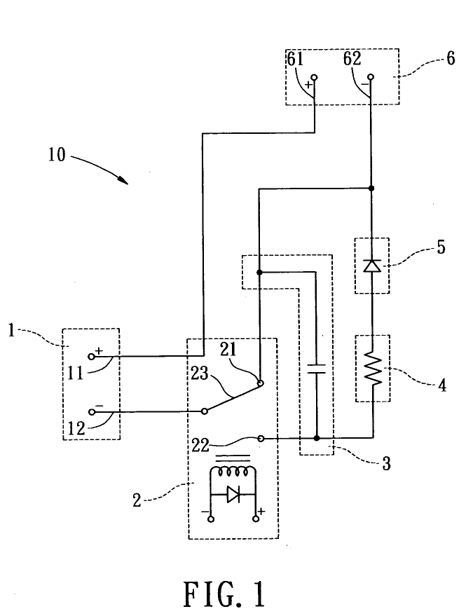

Please refer to FIG. 1, which is a diagram showing the circuit of the standby current generator according to one preferred embodiment of the present invention. The standby current generator 10 for an ozonizer of a multifunctional oxygenated water machine provided in the present invention is mainly connected between an ozonizer power source and the ozonizer. When the multifunctional oxygenated water machine is turned off, the standby current generator provides a standby current about 100 mA to hold the ozonizer at a standby status so that the ozonizer can have an optimal performance at all time and longer a lifespan.

The above mentioned standby current generator includes a first connecting terminal 1, a switch unit 2 connected with the first connecting terminal 1, a first protection unit 3 connected with the switch unit 2, a second protection unit 4 connected with the switch unit 2 and the first protection unit 3, a rectifying unit 5 connected with the switch unit 2 and the second protection unit 4, and a second connecting terminal 6 connected with the rectifying unit 5 and the switch unit 2.

The first connecting terminal 1 includes a positive connecting terminal 11 and a negative connecting terminal 12 for the ozonizer power source. The positive connecting terminal 11 and the negative connecting terminal 12 are connected with the ozonizer.

The switch unit 2 is a relay having a first input terminal connected with the negative connecting terminal 12 of the first connecting terminal 1 and a second input terminal connected with a microprocessor unit. The switch unit 2 further has a first output conductive terminal 21 and a second output conductive terminal 22 respectively connected with the first protection unit 3 and the second protection unit 4 for being controlled by the microprocessor unit in order to switch to the first output conductive terminal 21 or the second output conductive terminal 22.

The first protection unit 3 is a surge absorber. When the circuit is fleetly turned off, the original applied high current (surge signal) is absorbed by the first protection unit 3 in order to prevent the ozonizer from being damaged by the high current.

The second protection unit 4 is a current limiter for limiting the passing high current. In other words, the original applied current 12A is limited to the low standby current about 100 mA so as to hold the ozonizer at a standby status.

The rectifying unit 5 is a diode or a bridge rectifier for rectifying a suitable power output.

The second connecting terminal 6 includes a positive connecting terminal 61 and a negative connecting terminal 62 for the power source. The positive connecting terminal 61 and the negative connecting terminal 62 are connected with the ozonier power source. As such, the standby current generator that can generate a low standby current for the ozonizer is accomplished.

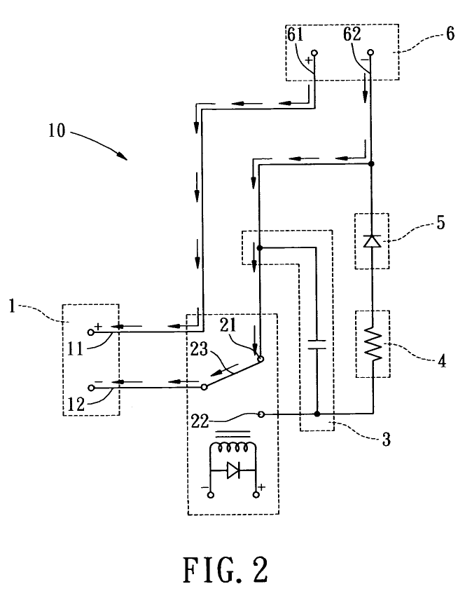

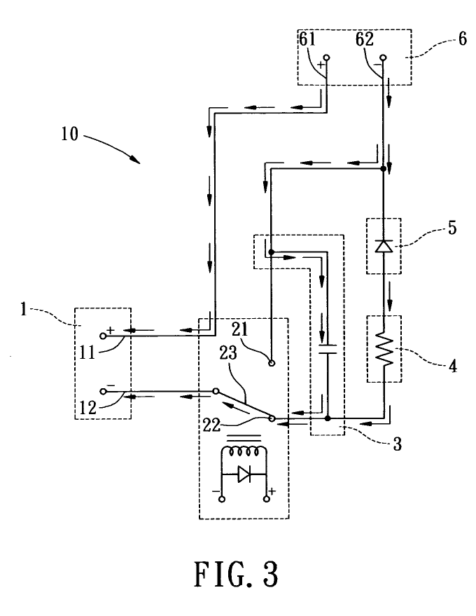

Please refer to FIGS. 2-3, which are diagrams showing the current directions in the circuit of the standby current generator according to one preferred embodiment of the present invention. As shown in the drawings,normally a conductive piece 23 of the switch unit 2 is switched to the first output conductive terminal 21 so that the ozonizer power source directly provides the needed power for the ozonizer. When the multifunctional oxygenated water machine is turned off, the conductive piece 23 of the switch unit 2 is switched to the second output conductive terminal 22 so that the transient high current is absorbed by the first protection unit 3. The original applied current 12A is limited to the low standby current about 100 mA by the second protection unit 4 in order to hold the ozonizer at a standby status.

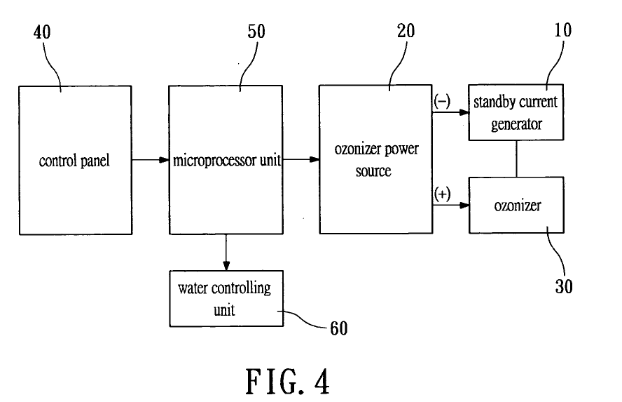

Please refer to FIG. 4, which is a flow chart showing the operating status of the standby current generator according to one preferred embodiment of the present invention. As shown in the drawing, when connecting the standby current generator 10 with the multifunctional oxygenated water machine, the standby current generator 10 is connected to the negative connecting terminal 12 of the ozonizer power source 20 and the negative connecting terminal 62 of the ozonizer 30.

When a control panel 40 is operated, the signal is output to the microprocessor unit 50 such that the water controlling unit 60, the ozonizer power source 20, and the ozonizer 30 are controlled by the microprocessor unit 50. Accordingly, the desired ozonated water or the potable electrolised ozonated water is generated.

When the multifunctional oxygenated water machine is turned off, the standby current generator 10 reduces the applied high current to the low standby current about 100 mA in order to hold the ozonizer 30 at a standby status. Therefore, it provides the ozonizer 30 having an optimal performance at all time and a longer lifespan. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A standby current generator for an ozonizer, which is connected between an ozonizer power source and the ozonizer of a multifunctional oxygenated water machine, comprising:
a first connecting terminal connected with the ozonizer;
a switch unit connected with the first connecting terminal;
a second protection unit connected with the switch unit;
a rectifying unit connected with the switch unit and the second protection unit; and
a second connecting terminal connected with the rectifying unit and the switch unit;
thereby when the multifunctional oxygenated water machine is turned off, an applied high current provided by the ozonizer power source to the ozonizer is reduced to a low standby current to hold the ozonizer at a standby status.

2. The standby current generator for an ozonizer according to claim 1, wherein the first connecting terminal further comprises a positive connecting terminal and a negative connecting terminal for the ozonizer power source.

3. The standby current generator for an ozonizer according to claim 1, wherein the switch unit is a relay which has a first input terminal connected with a negative connecting terminal of the first connecting terminal and a second input terminal connected with a microprocessor unit.

4. The standby current generator for an ozonizer according to claim 3, wherein the relay further has a first output conductive terminal and a second output conductive terminal respectively connected with a first protection unit and the second protection unit.

5. The standby current generator for an ozonizer according to claim 4, wherein the first protection unit is a surge absorber

6. The standby current generator for an ozonizer according to claim 1, wherein the second protection unit is a current limiter.

7. The standby current generator for an ozonizer according to claim 1, wherein the rectifying unit is a diode.

8. The standby current generator for an ozonizer according to claim 1, wherein the rectifying unit is a bridge rectifier.

9. The standby current generator for an ozonizer according to claim 1, wherein the second connecting terminal further comprises a positive connecting terminal and a negative connecting terminal for the ozonie power source.

10. A standby current generator for an ozonizer, which is connected between an ozonizer power source and the ozonizer of a multifunctional oxygenated water machine, comprising:
a first connecting terminal connected with the ozonizer;
a switch unit connected with the first connecting terminal;
a first protection unit connected with the switch unit;
a second protection unit connected with the switch unit and the first protection unit;
a rectifying unit connected with the switch unit and the second protection unit; and
a second connecting terminal connected with the rectifying unit and the switch unit;
thereby when the multifunctional oxygenated water machine is turned off, an applied high current provided by the ozonizer power source to the ozonizer is reduced to a low standby current to hold the ozonizer at a standby status.

11. The standby current generator for an ozonizer according to claim 10, wherein the first connecting terminal further comprises a positive connecting terminal and a negative connecting terminal for the ozonizer power source.

12. The standby current generator for an ozonizer according to claim 10, wherein the switch unit is a relay which has a first input terminal connected with a negative connecting terminal of the first connecting terminal and a second input terminal connected with a microprocessor unit.

13. The standby current generator for an ozonizer according to claim 12, wherein the relay further has a first output conductive terminal and a second output conductive terminal respectively connected with the first protection unit and the second protection unit.

14. The standby current generator for an ozonizer according to claim 10, wherein the first protection unit is a surge absorber

15. The standby current generator for an ozonizer according to claim 10, wherein the second protection unit is a current limiter.

16. The standby current generator for an ozonizer according to claim 10, wherein the rectifying unit is a diode.

17. The standby current generator for an ozonizer according to claim 10, wherein the rectifying unit is a bridge rectifier.

18. The standby current generator for an ozonizer according to claim 10, wherein the second connecting terminal further comprises a positive connecting terminal and a negative connecting terminal for the ozonie power source.
